(19) United States
(12) Patent Application Publication
(10) Pub. No.: US 2025/0386343 A1
(43) Pub. Date: Dec. 18, 2025

(54) COMMON SIGNAL AND CHANNEL ADAPTATION BASED ON UE NEEDS

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Hung Dinh LY, San Diego, CA (US)

(21) Appl. No.: 18/744,548

(22) Filed: Jun. 14, 2024

(51) Int. Cl. H04W 72/20

(52) U.S. Cl. CPC H04W 72/20

(57) ABSTRACT

This disclosure provides approaches for improving energy efficiency in 5G networks through the use of on-demand operations and the adaptation of common signals and channels. The disclosed methods and apparatuses allow for a more efficient use of network resources and energy, leading to significant energy savings. Methods of wireless communication performable at a user equipment (UE) are accordingly provided which allow the UE to receive indications from the network about possible adaptations, determine whether to request adaptations based on these indications, and transmit requests for specific adaptations when necessary. This approach allows for a more tailored and efficient communication between the UE and the network, thereby enhancing the overall energy efficiency of the network and improving the performance of wireless communication.

### TECHNICAL FIELD

The present disclosure generally pertains to the field of wireless communication, and more particularly, to strategies for improving energy efficiency in 5G networks through the use of on-demand operations and the adaptation of common signals and channels.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, which may be a user equipment (UE). The apparatus includes one or more memories, and one or more processors each communicatively coupled with at least one of the one or more memories. The one or more processors, individually or in any combination, are operable to cause the apparatus to obtain an indication that a network entity is in an operation mode to adapt, based on a request from a user equipment (UE), one or more parameters associated with a common signal or a common channel for a plurality of UEs including the UE; and receive or transmit the common signal or the common channel including an adaptation of the one or more parameters following the indication.

Another innovative aspect of the subject matter described in this disclosure may be implemented in a method for wireless communication performable at a UE. The method includes obtaining an indication that a network entity is in an operation mode to adapt, based on a UE request, one or more parameters associated with a common signal or a common channel for a plurality of UEs including the UE; and receiving or transmitting the common signal or the common channel including an adaptation of the one or more parameters following the indication.

Another innovative aspect of the subject matter described in this disclosure may be implemented in an apparatus for wireless communication, which may be a UE. The apparatus includes means for obtaining an indication that a network entity is in an operation mode to adapt, based on a request from a UE, one or more parameters associated with a common signal or a common channel for a plurality of UEs including the UE; and means for receiving or means for transmitting the common signal or the common channel including an adaptation of the one or more parameters following the indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram illustrating an example of a base station and a UE involved in wireless communication.

FIG. 4 is a diagram illustrating an example of synchronization signal block (SSB) timing within a SSB burst set.

FIG. 5 is a diagram illustrating an example of random access channel (RACH) occasions associated with a physical random access channel (PRACH) configuration index.

FIG. 6 is a block diagram illustrating an example of paging frames that include SSBs and paging occasions (POs).

FIG. 7 is a block diagram illustrating an example of paging frames that include POs indicated in a paging early indication (PEI).

FIG. 8 is a block diagram illustrating an example of an indication in PEI of a PO for a subgroup of UEs.

FIG. 9 is a block diagram illustrating an example of a timeline showing an interaction between the network and the UE in the context of signal and channel adaptation.

FIG. 10 is a diagram illustrating an example of a call flow between a base station and a UE.

FIG. 11 is a flowchart of an example method of wireless communication performable at a UE.

FIG. 12 is a diagram illustrating an example of a hardware implementation for an apparatus that is a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

As 5G networks continue to evolve rapidly, the importance of energy efficiency has become increasingly apparent. Strategies to enhance energy efficiency are being explored, with a key focus on the concept of on-demand operations. This approach involves activating certain network functions only when necessary, which can lead to significant energy savings. Another strategy under exploration involves the adaptation of common signals such as synchronization signal blocks (SSBs) and tracking reference signals (TRSs), or common channels like the paging channel (PCCH) or physical random access channel (PRACH) in both the time and spatial domains. However, while these adaptations have the potential to save network energy, it is important that the addition of extra resources or other adaptation approaches are implemented judiciously to avoid unnecessary waste.

In light of these challenges, the present disclosure introduces strategies that allow the network to increase, decrease, or otherwise adapt the transmissions of SSBs, PRACH, paging, TRS, or other common signals and channels, based on the specific needs of the User Equipment (UE). These strategies, which focus on on-demand operations and the adaptation of signal and channel transmissions, offer an interactive and flexible approach to the adaptation of common signals and channels, thereby enhancing network energy efficiency. By enabling the network to indicate possible adaptations and allowing the UE to request specific adaptations, a more efficient use of network resources and energy can be achieved. This approach not only optimizes energy usage but also ensures that the adaptations made are beneficial to both the network and the UE, thereby addressing the challenges associated with energy efficiency in 5G networks.

In one aspect, the network may indicate to the UE the possible adaptations the base station may apply to common signals and channels. For example, the base station may provide candidate configurations of one or more common signals or channels, such as multiple configurations respectively including different SSB periodicities, different quantities of PRACH resources, or a combination of such configurations, which the UE may select in a request. This allows for a more tailored approach to network adaptations, ensuring that changes are made based on the specific needs of the UE, thereby enhancing the efficiency of network resource usage and potentially leading to significant energy savings.

In another aspect, the network may indicate to the UE whether or not the UE may request the adaptation of common signals or channels in general. For example, the network could send an indication to the UE that enables or disables a general feature of UE request of such common signals or channels. This allows for greater control over network adaptations, as it gives the network the ability to limit when adaptations may be requested, thereby preventing unnecessary changes that could lead to resource wastage and ensuring that adaptations are made only when they are likely to be beneficial.

In a further aspect, the network may indicate to the UE which signals or channels the UE is allowed to request for adaptation. For example, the base station may indicate to the UE whether the UE may request adaptations only for SSBs, only for PRACH, or any combination of these and other common signals or channels. This allows the network to restrict UE requests to certain signals or channels that the network is configured or capable to adapt, thereby compacting UE requests and simplifying request signaling. This signal or channel-specific restriction may also help to ensure that the network's resources are used efficiently and that the adaptations made are useful to both the network and the UE. This approach can lead to more effective network management, as it ensures that adaptations are focused on the areas where they are most needed and can have the greatest impact.

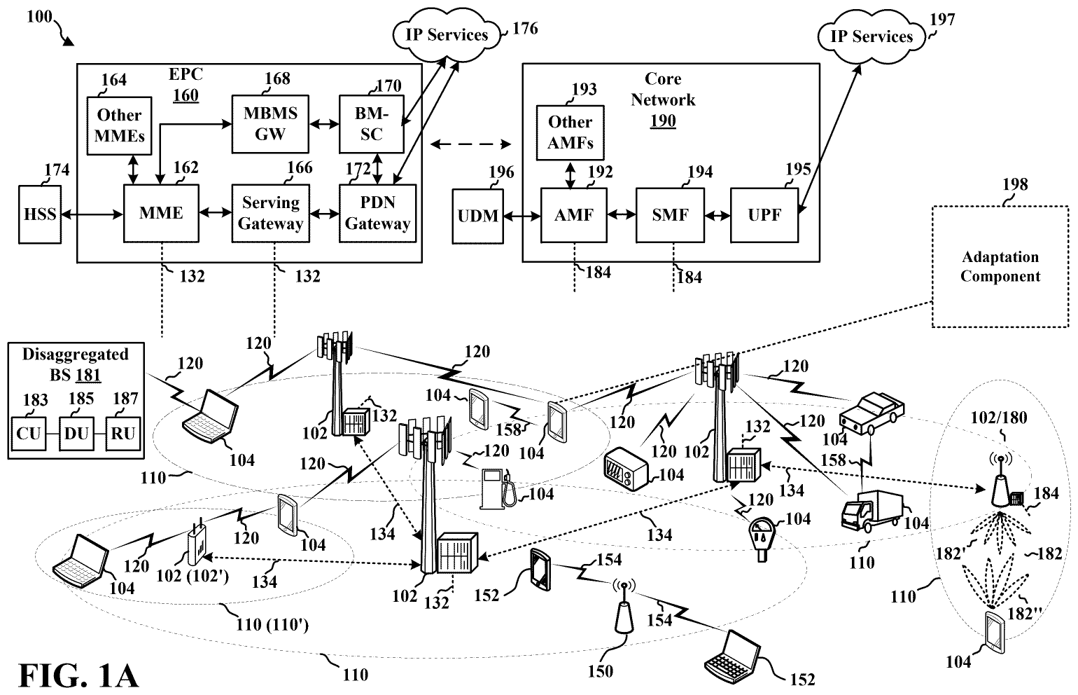

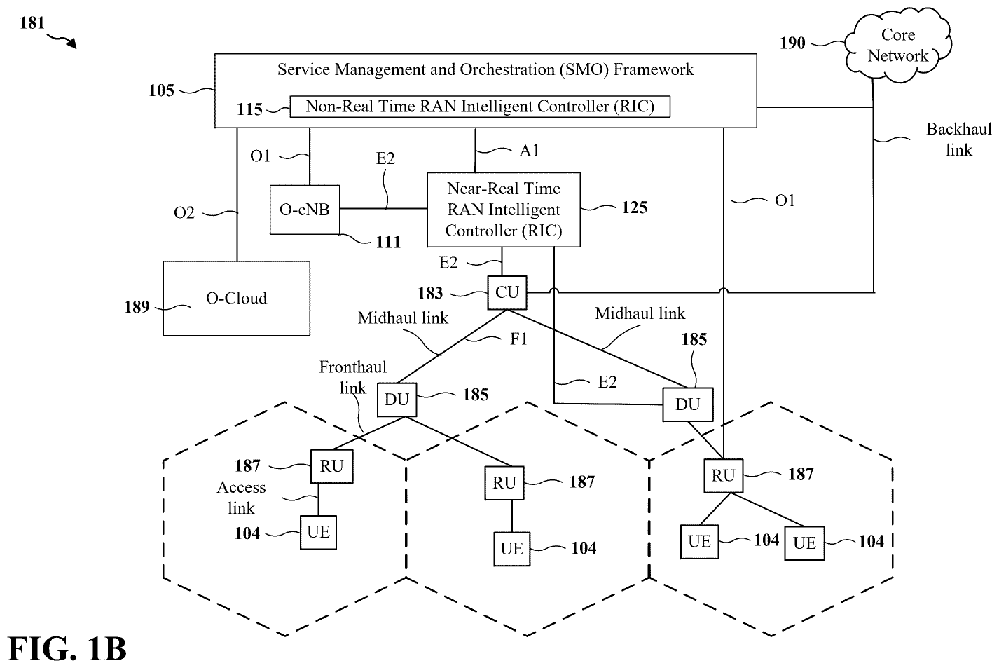

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

Referring to FIGS. 1A and 1B, in certain aspects, the UE 104 may include an adaptation component 198 that is configured to obtain an indication that a network entity is in an operation mode to adapt, based on a request from a UE, one or more parameters associated with a common signal or a common channel for a plurality of UEs including the UE; and receive or transmit the common signal or the common channel including an adaptation of the one or more parameters following the indication. The UE may obtain the indication from base station 102/180, disaggregated base station 181, a component of disaggregated base station 181 such as CU 183, DU 185, or RU 187, or some other network entity.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

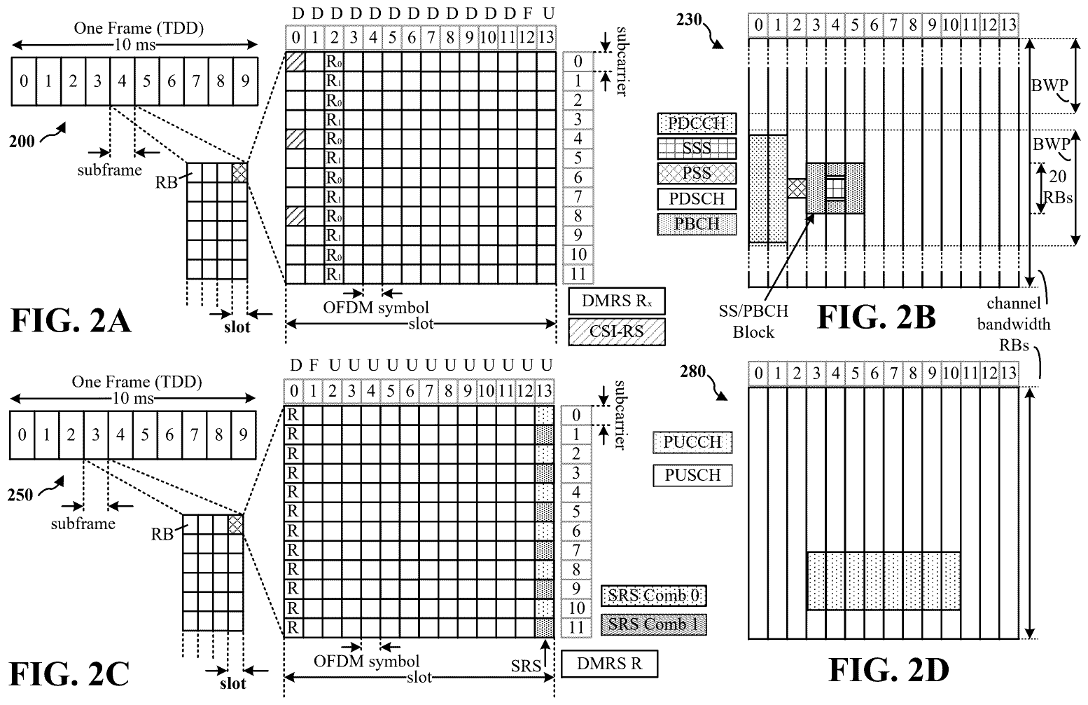

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies u 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2\hat{ }μ*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE may determine a physical cell identifier (PCI). Based on the PCI, the UE may determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

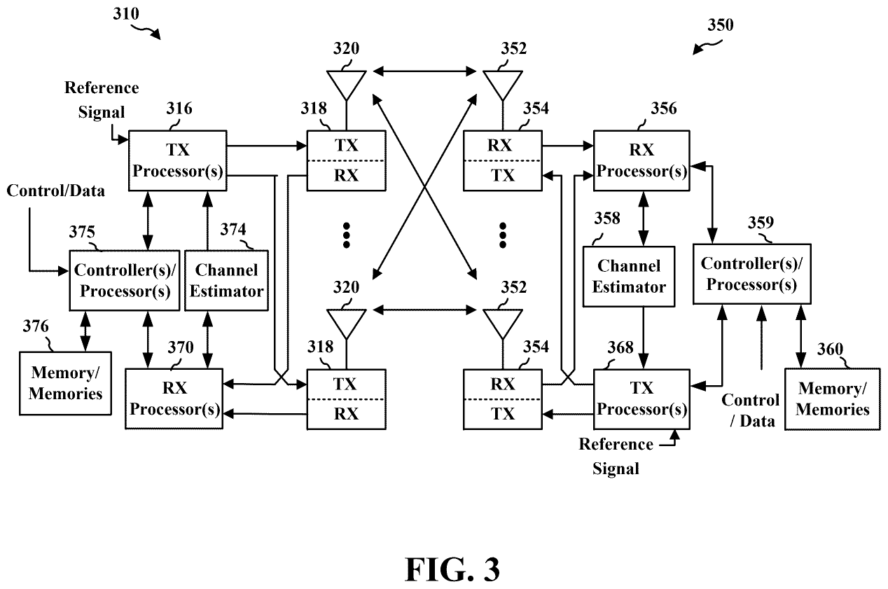

FIG. 3 is a block diagram of a base station 310 such as base station 102/180 in communication with a UE 350 such as UE 104 in an access network. IP packets from the EPC 160 may be provided to one or more controllers/processors 375 of base station 310. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 of base station 310 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 of UE 350 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359 of UE 350, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with transmission by the base station 310, the one or more controllers/processors 359 of UE 350 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). The one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359, may be configured to perform aspects in connection with adaptation component 198 of FIG. 1A.

In the evolving landscape of 5G networks, energy efficiency is a key area of focus. One of the strategies being explored to achieve this is on-demand operations. For instance, a synchronization signal block (SSB) of a secondary cell (Scell) for a UE in a radio resource control (RRC) connected state with carrier aggregation (CA) may be operated on-demand. Carrier Aggregation is a technique that increases the data rate and capacity of the network by using multiple frequency bands simultaneously. Thus, instead of the SSB being continuously active, it is triggered when needed, leading to potential energy savings.

The triggering of these on-demand operations may be achieved through various methods. One such method is an uplink (UL) wake-up signal, a signal sent from the UE to the network indicating that it is active and ready to receive data. Another method may be through cell on or off indications via the backhaul, the connection between the base station and the network core. Yet another method may be through Scell activation or deactivation signaling, which involves signals used to activate or deactivate a Scell. Similarly, the system information block type 1 (SIB1), which contains important information for the UE to communicate with the network, may also be made available on-demand for UEs in RRC idle or inactive states. The triggering method for this on-demand SIB1 may be an UL wake-up signal, for example. The configuration of the wake-up signal, which does not involve any changes to the SSB or SIB1, is another area of focus. Information exchange between base stations is considered for this configuration, particularly to coordinate the timing of the wake-up signal to avoid interference.

Adaptation of signal and channel transmissions is another strategy being explored for energy savings. This includes adaptations in the time-domain for the SSB and the physical random access channel (PRACH), which is used by the UE to make initial contact with the network. The adaptation in the time-domain may involve, for example, adjusting the timing of the signals to optimize the use of the spectrum. For instance, an SSB or physical broadcast channel (PBCH) periodicity, or a timing of some other common signal or channel, may be adjusted dynamically or semi-statically. Additionally, the adaptation of PRACH in the spatial domain is being studied. This may involve adjusting the direction and shape of a signal beam associated with a PRACH occasion to avoid interference, or adjusting where the PRACH signals are sent based on the locations of the UEs, for example. The adaptation of paging occasions, times when the network sends a paging message to the UE to notify it of incoming data, is also part of this strategy. For example, a number of transmitted or monitored PRACH occasions or paging occasions may be reduced or confined to a shorter amount of time based on the UEs' activity patterns, allowing the network to enter longer sleep states and achieve more energy savings.

The adaptation of common signals or common channels may be important for network efficiency and resource saving. For instance, the base station may adapt the transmission of common signals such as SSBs, PRACH in the time domain, PRACH in the spatial domain, and paging occasions based on the load of the network. For example, in a low load scenario, instead of transmitting SSBs every 20 milliseconds, the network may transmit them every 80 milliseconds to reduce the load on the network, or the network may reduce a number of active SSBs in an SSB burst set. If the load increases, the network may change the periodicity of transmission back to 20 milliseconds or increase the number of active SSBs in the SSB burst set, and vice versa. The same principle applies to other common signals and channels, including the PRACH and the paging control channel (PCCH).

An SSB may include synchronization signals (SS) that a UE may use to derive system information to access a cell. An SS burst set may include a set of one or more SSBs, where each SSB in the SS burst set may potentially be transmitted on a different beam (e.g. a different one of the transmit directions 182′ in FIG. 1A). The UE may similarly receive each SSB on a different beam (e.g. a different one of the receive directions 182″ in FIG. 1A). For instance, assuming an SSB periodicity of 20 ms or two 10 ms radio frames, the base station may transmit an SS burst set of one or more SSBs within a first-half or second-half of one of the radio frames (i.e. a 5 ms window within each 20 ms period), with each SSB being transmitted in a different beam. The maximum number of SSBs within each burst set may depend on the carrier frequency of the cell. For example, for frequencies above 6 GHz, at most 64 SSBs may be transmitted within a single SS burst set. Moreover, the starting OFDM symbol index for each SSB within an SS burst set may depend on the carrier frequency of the cell and the subcarrier spacing (SCS). For example, for frequencies above 6 GHz, SSBs may be transmitted starting at OFDM symbols 4, 8, 16, and 20 for 120 kHz SCS and starting at OFDM symbols 8, 12, 16, 20, 32, 36, 40, and 44 for 240 kHz SCS.

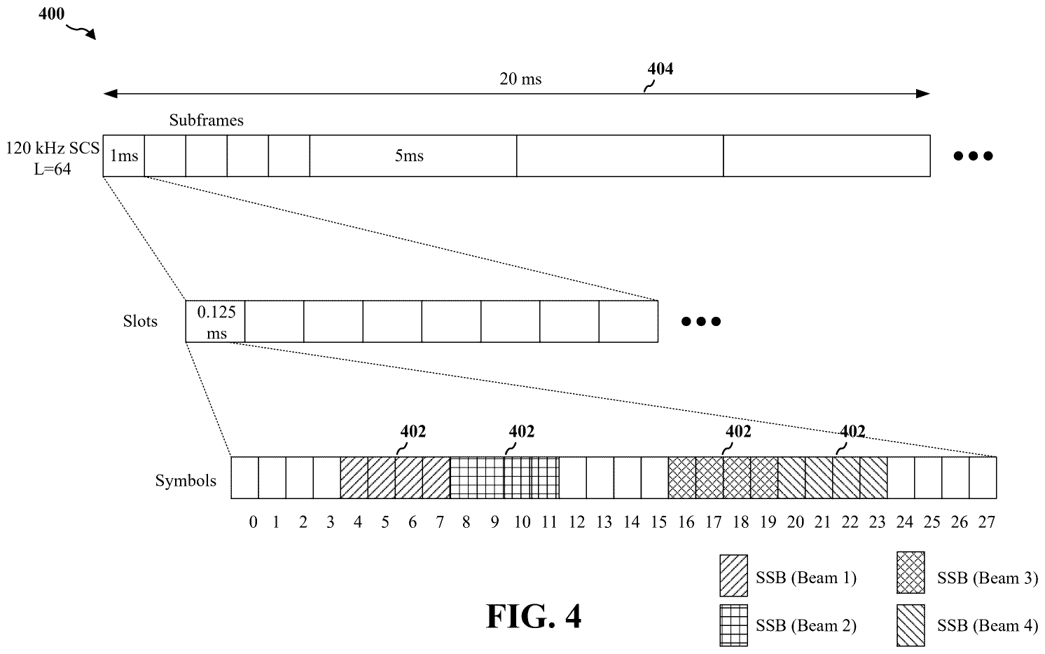

FIG. 4 illustrates an example 400 of a timing of SSBs 402 within an SS burst set having a configured, SSB periodicity 404 of 20 ms, a SCS of 120 kHz, and 64 candidate SSBs. In this example, each SSB 402 corresponds to a different beam (e.g. each SSB is transmitted in a different one of the transmit directions 182′ of FIG. 1A), in this case beams 1, 2, 3, and 4. Moreover, as illustrated, each 1 ms subframe at 120 kHz SCS may be divided into eight 0.125 ms slots, with each slot spanning 28 OFDM symbols. Furthermore, the starting symbol of each SSB 402 in this example begins at OFDM symbols 4, 8, 16, and 20. Similar SSB patterns may be configured in other examples at other SCS (e.g. 240 kHz).

The base station may configure which SSBs within an SS burst set are active in an SIB1. For instance, the base station may provide a common serving cell configuration, such as ServingCellConfigCommonSIB, which informs the UE as to which SSBs are being transmitted using a configuration of SSB burst positions, such as ssb-PositionsInBurst. For example, the SSB burst position configuration may include one or more fields informing the UE which SSBs are being transmitted, and thus the time domain positions of SSBs the UE may receive, using a bitmap where a value of 0 indicates a corresponding SSB is not transmitted while a value of 1 indicates a corresponding SSB is transmitted (or vice-versa). Based on the SS burst position configuration, the UE may determine whether or which SSBs 402 the base station will transmit. For instance, if an SS burst position configuration indicates a bitmap ‘1010’, the UE may determine in FIG. 4 that SSBs 402 will be transmitted beginning at symbols 8 and 20 on beams 2 and 4, respectively, but that no SSB will be transmitted beginning at symbols 4 and 16 on beams 1 and 3, respectively. The UE may then determine to initially access a cell, for example using a random access channel (RACH) procedure, based on system information received in the transmitted SSBs.

PRACH is a channel that UEs may use to initiate communication with the network. For instance, a UE may perform a RACH procedure beginning with a preamble transmission in PRACH to establish a connection for data transmission or when trying to recover from a beam failure. Cell-specific random-access parameters that the UE may apply for both contention-based and contention-free random access (RA), as well as for contention-based beam failure recovery, may be specified in RACH configurations, such a common RACH configuration, RACH-ConfigCommon. The common RACH configuration includes a variety of fields, information elements or configurations, each carrying specific information that helps in the efficient management of the PRACH. One such configuration is a generic RACH configuration, RACH-ConfigGeneric, which specifies the random-access parameters for both regular random access and beam failure recovery. This configuration includes parameters such as a PRACH configuration index, which determines how the PRACH is set up and how it operates. For instance, the PRACH configuration index may be associated with specific parameters such as the preamble format, PRACH periodicity (n_{SFN} mod x=y), subframe number, starting symbol, number of PRACH slots within a subframe, number of time-domain PRACH occasions within a PRACH slot, and PRACH duration. The UE may determine the mapping of the preamble sequence to physical resources, or RACH occasions (ROs) in which preambles may be transmitted, based on this configuration

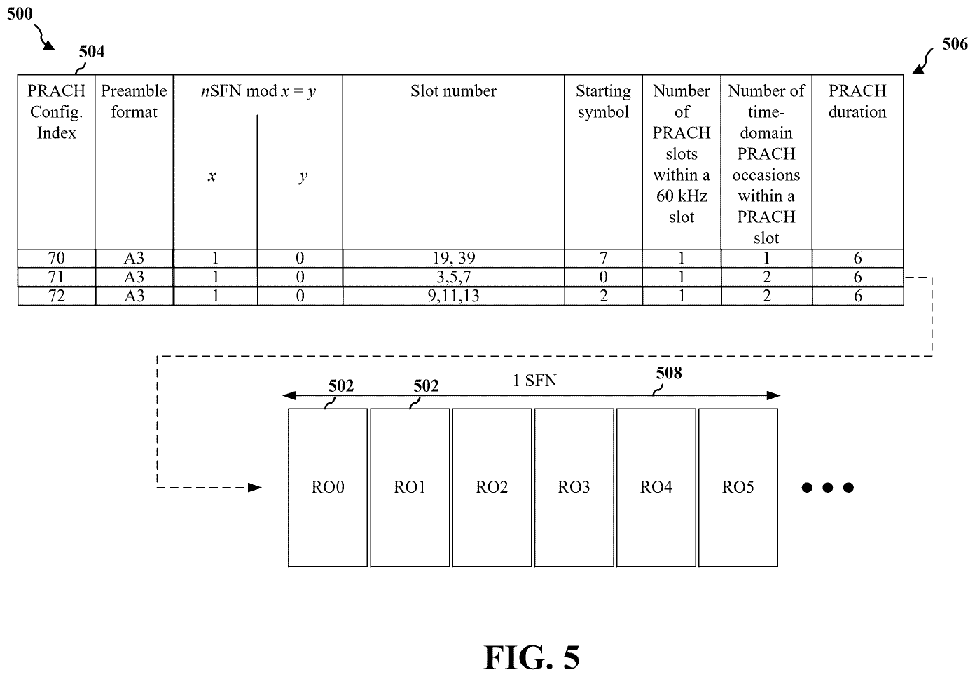

FIG. 5 illustrates an example 500 of ROs 502 associated with a PRACH configuration index 504 indicated in a RACH configuration the UE receives from a base station. In this example, a PRACH configuration index of 71 from a time resource mapping table 506 including 256 PRACH configuration indices is configured for PRACH transmissions, although a different PRACH configuration index may be indicated in other examples. As illustrated, the PRACH configuration index may be associated with a PRACH preamble format, a PRACH periodicity 508 such as 1 system frame (SFN) in this example, and other timing information for ROs 502, such as slot number, starting symbol, number of PRACH slots within a 60 kHz slot, number of ROs within a PRACH slot, and PRACH duration. SSBs 402 associated with different beams may be mapped to ROs 502, and after the UE selects a beam for preamble transmission corresponding to one of these SSBs 402, the UE may transmit a preamble using the selected beam in the corresponding RO(s) mapped to that SSB. The base station may then determine which SSB beam a UE has selected based on the RO(s) in which the preamble is transmitted.

Paging is a process used by the network to notify a UE of incoming data or signaling messages. The network may page the UE in case of, for instance, a system information update or the reception of downlink signaling. Thus, if the network intends to transmit some downlink signaling to the UE, it will initiate paging. The UE monitors a paging channel during a paging occasion (PO) per discontinuous reception (DRX) cycle. The DRX cycle is a period during which the UE alternates between awake and sleep states to save power. The default DRX period is broadcasted in system information (SI), but a UE-specific period for DRX may be configured through non-access stratum (NAS) signaling or RRC signaling. The UE, when in idle mode, may wake up at a specific time in the DRX period to measure an SSB 402 to maintain time and frequency synchronization. After this, the UE may wait for its specific paging frame. If there is no paging, the UE may go back to sleep. If the UE detects the paging, it will perform initial access, for instance beginning with a PRACH preamble transmission in RO(s) 502 associated with the SSB 402, changing its status to RRC connected. Once it is in RRC connected status, the network may schedule the downlink signaling.

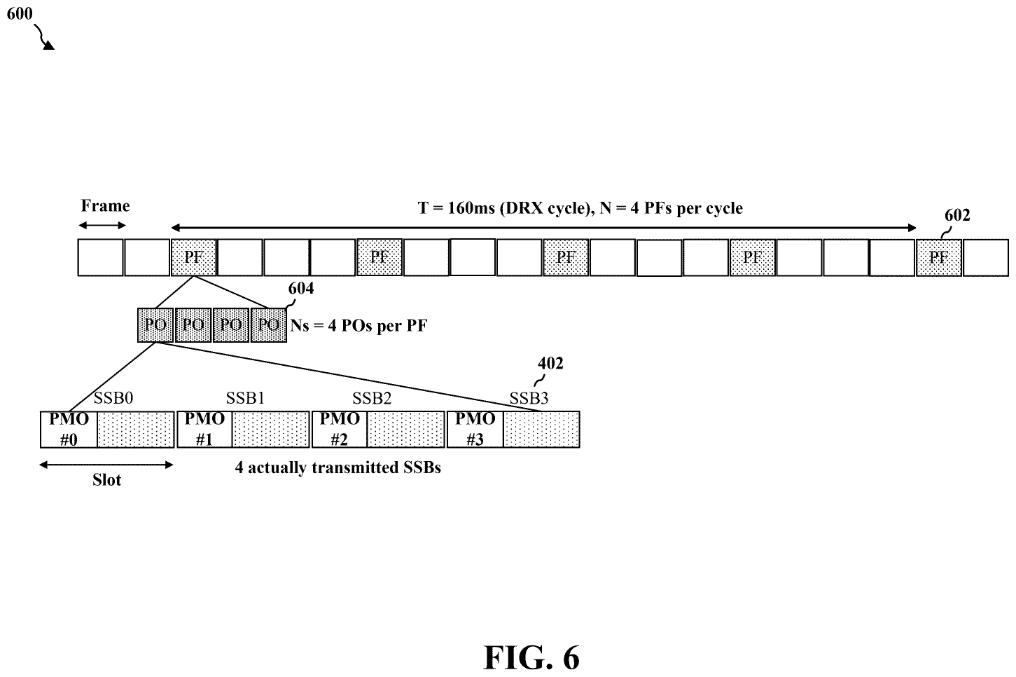

FIG. 6 provides an example 600 of paging frames 602 that include SSBs 402 and POs 604. Paging frames 602 are part of the cycles determined by system information. In this example, there are four paging frames that are uniformly spaced within a 160 ms DRX cycle or paging cycle, although different numbers N of paging frames 602 or cycle timings may be configured in other examples. Within each paging frame 602, there are paging occasions or POs 604. The number of POs 604 in a paging frame may be determined by a parameter Ns, which in this example is four but may alternatively be a different number given by system information. Within each paging occasion, there may be multiple paging monitoring occasions (PMOs). Each of these PMOs corresponds to a different one of the SSBs 402. The equation for determining a timing of one of the POs 604 may be as follows:

For the System Frame Number (SFN) for paging frame (PF):

$$( S F N + P {F}_{offset} ) mod T = \frac{T}{N} ( UEID mod N ) ,$$

For the PO index:

$$PO index : {i}_{s} = floor ( \frac{UEID}{N} ) mod {N}_{s} .$$

Here, SFN is a System Frame Number, PF_offset is an offset for the paging frame, T is a total number of frames, N is a number of UEs, UEID is a user equipment identifier, and N_s is the number of paging occasions.

In the above example, the UE may wake up to measure the SSB 402 for one of the paging frames 602, even if the network is not going to send paging in PO 604. To address this inefficiency, PEI was introduced. The early indication allows the UE to ascertain in advance if there will be paging. This can help to save energy by reducing unnecessary wake-ups, thereby improving the energy efficiency of the network.

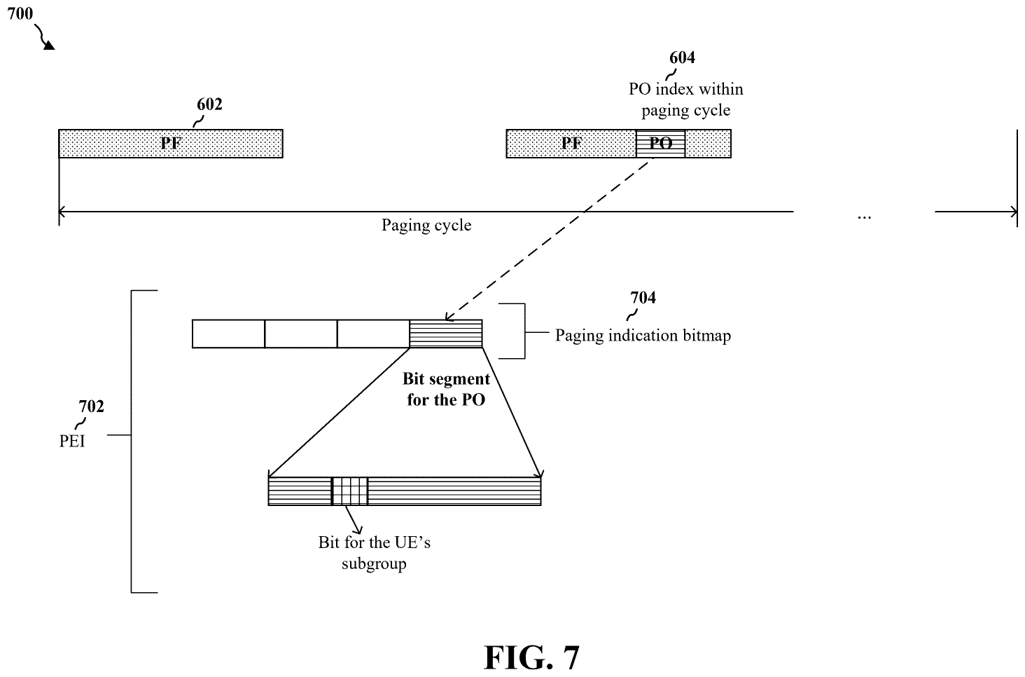

FIG. 7 illustrates an example 700 of paging frames 602 that include POs 604 indicated in a PEI 702. The PEI 702 indicates a certain number of POs, referred to as POnumPerPEI, in one or two consecutive paging frames (PFs). The value range of POnumPerPEI may be {1, 2, 4, 8} in one example, indicating respectively 1, 2, 4, or 8 POs, although the value range may be different in other examples. POnumPerPEI is a factor of the total number of POs in a paging cycle. Thus, the total number of POs 604 in a paging cycle may be a multiple of POnumPerPEI.

The value of POnumPerPEI, which is the number of POs 604 indicated by the PEI 702, may be smaller than the number of POs 604 per PF, denoted as N_s. However, when POnumPerPEI is larger than N_s, it may be a multiple of N_s. This ensures that the number of POs 604 indicated by the PEI 702 aligns with the number of POs per PF.

The PEI 702 also includes a paging indication bitmap 704. This bitmap 704 has POnumPerPEI bit segment(s), each of K bits. The value of K may be equal to subgroupsNumPerPO if subgrouping is configured, otherwise K may be equal to 1. Subgrouping refers to the division of UEs into subgroups for more efficient signaling. Thus, instead of signaling all UEs at once, the network may signal specific subgroups of UEs in PEI 702, which may help to manage the communication load and ensure more efficient use of the network resources. The size of the bitmap 704 in the PEI 702 may thus be POnumPerPEI×subgroupsNumPerPO if subgrouping is configured. If subgrouping is not configured, the size of the bitmap may be equal to POnumPerPEI.

The UE 104, 350 determines the index of its associated bit segment in bitmap 704 based on the PO index within the paging cycle. The PO index is consecutively counted for POs 604 across all PFs 602 in the paging cycle. The UE maps the PO index across all PFs 602 to a bit segment based on the relative PO index within the bitmap 704. This PO index may be calculated using the following formula:

$$i\_PO = ( ( UE\_ID mod N ) \times N\_s + i\_s ) mod POnumPerPEI ,$$

where N is the total number of paging frames in the paging cycle, N_s is the index of the PO 604 within the paging frame 602, and POnumPerPEI is the number of POs 604 indicated by the PEI 702.

If subgrouping is configured, within the bit segment of bitmap 704, the bit that is used as the paging indication for the UE's subgroup is determined by the UE's subgroup index i_SG. This is represented by the bit i_PO×K+i_SG of the paging indication bitmap 704, where K may be equal to subgroupsNumPerPO if subgrouping is configured, otherwise K may be equal to 1. The value of the bit determines whether the UE processes the paging DCI in PO 604. If the bit value is 1, the UE processes the paging DCI. If the bit value is 0, the UE does not process the paging DCI. This allows the network to control which UEs process the paging DCI, which may save energy by reducing unnecessary operations.

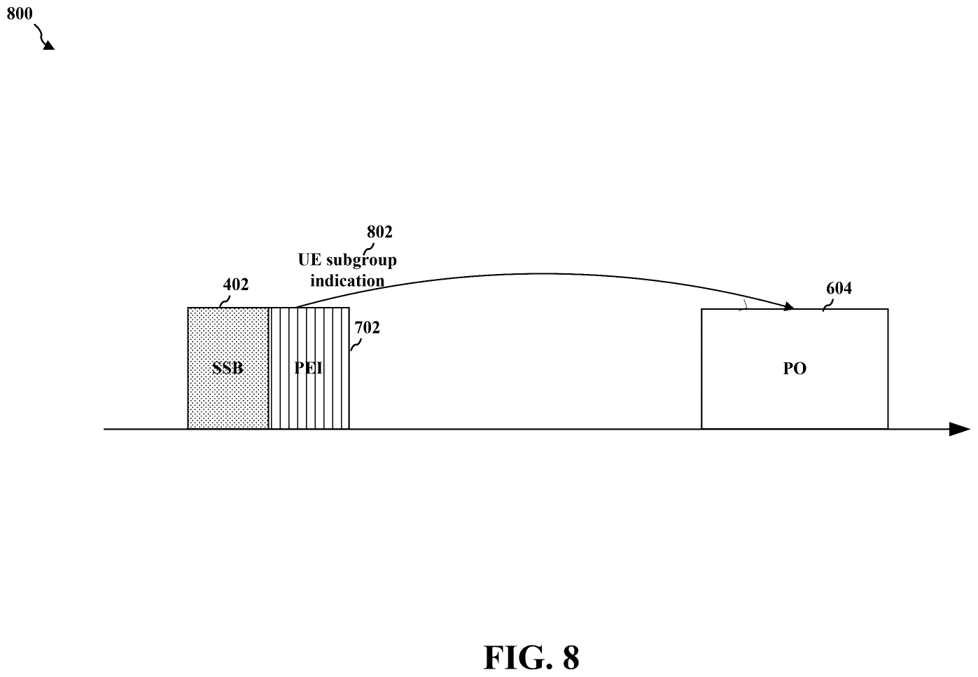

FIG. 8 illustrates an example 800 of an indication 802 in PEI 702 of the PO 604 for a subgroup of UEs 104, 350. The PEI 702 may be transmitted immediately after SSB 402. The UE wakes up to measure the SSB 402 and receives the PEI 702. If the PEI 702 informs the UE that it will receive paging, then the UE may wake up again to receive the paging in PO 604. However, if the PEI 702 informs the UE that it will not receive paging, then the UE does not wake up again and may return to sleep until the next paging cycle. By waking up only when there is an indication to receive paging, the UE may conserve energy, thereby improving the overall energy efficiency of the network.

In the given example 800, different UEs 104, 350 may receive paging at different times. The PEI 702 may inform UEs about the paging frames 602 in the cycle. The PEI 702 may provide information about up to two paging frames and up to eight paging occasions in a cycle. The PEI 702 may provide advance notice to multiple UEs about when they will need to wake up to receive paging DCI in PO(s) 604. By providing advance notice to the UEs, the PEI 702 allows them to stay in sleep mode until they need to wake up to receive paging.

The paging DCI received in PO(s) 604 may include paging information which may, or may not, be associated with a paging message in that PO. The paging DCI may be transmitted on the PDCCH using a DCI format 1_0, having a cyclic redundancy check (CRC) scrambled by a paging radio network temporary identifier (P-RNTI), with or without an associated paging message. If the paging DCI is associated with a paging message for the UE, the paging DCI may include a frequency domain resource assignment, a time domain resource assignment, a modulation and coding scheme, and other information related to the paging message. If the paging DCI is not associated with a paging message for the UE, these fields may be reserved. In addition to, or alternatively to, being associated with a paging message, the paging DCI may include a short message indicator and a short message, or a tracking reference signal (TRS) availability indication. The short message indicator may indicate whether only paging scheduling information and TRS availability indication are present using one bitmap value, whether only a short message and a TRS availability indication are present using another bitmap value, or whether paging scheduling information, TRS availability indication, and short message are present using a further bitmap value. If a short message is transmitted, the short message may indicate a system information modification using one bit value informing whether a broadcast control channel (BCCH) modification other than SIB6, SIB7, SIB8, and position SIBs is present, a stop paging monitoring indication using another bit value informing whether the UE may stop monitoring PDCCH occasions for paging in a PO, and other indications using other bit values.

Thus, in one example putting together the concepts described with respect to FIGS. 4-8, the base station 102/180, 310 may transmit SSBs 402 indicating POs 604 of the UE 104, 350 or a subgroup of UEs, according to SSB periodicity 404 and configured SS burst positions. If the UE is in idle mode and there is an incoming call for it, the network may send PEI 702 in the DCI 2_7 format to alert the UE of an upcoming paging occasion. The UE may then monitor the paging channel during the indicated PO. When the UE receives a paging indication in the DCI 1_0 format of a PDCCH, which may or may not indicate a short message or a TRS, it may determine that there is a paging message for it. The network may then send the paging message on the PCCH, which is located within the same PO. In response to the paging message, the UE may establish a connection with the network to receive the call using a RACH procedure, beginning with transmission of a PRACH preamble in RO(s) 502 associated with SSBs 402, according to PRACH periodicity 508 associated with the PRACH configuration index 504 indicated to the UE.

The adaptation of common signals such as SSBs 402 and TRS, or common channels such as PCCH or PRACH in the time domain and spatial domain, is a focus in ongoing discussions of network energy saving or energy efficiency enhancement. Taking PRACH as an example, adaptation may occur by activating additional PRACH resources or ROs 502 for a UE. However, such adaptations may not necessarily help all the time in saving energy. For instance, if the network activates additional PRACH resources, it may end up consuming energy to monitor these resources. Moreover, there is a possibility that the UE might not need these additional resources, leading to potential waste. While these examples refer to PRACH, the concepts are equally applicable to other signals and channels as well.

Thus, while adaptation may ideally save network energy, it would be helpful if addition of extra resources or other adaptation approaches are done judiciously to minimize waste. For instance, the allocation of additional resources may be need-based rather than random. In one case, if the need for additional resources is determined by the network, for instance, if the network determines it would be helpful for more frequent SSB measurements, then the network may adapt the SSBs accordingly. On the other hand, if the need is based on the UE, for example, if UEs are experiencing high collision and it would thus be helpful to assign more PRACH resources, then the adaptation may be based on a UE request, for example through an uplink wake-up signal (WUS). Moreover, it would be helpful for the network to indicate to the UE that it is ready to activate more resources for a certain common channel or signal, or in other words, that the network is configured or capable to activate additional resources based on UE request. This indication from the network may ensure that additional resources are activated only when necessary, thereby optimizing energy usage.

Accordingly, aspects of the present disclosure allow the network to increase or decrease or otherwise adapt the transmissions of SSBs, PRACH, paging, TRS, or other common signals and channels, based on the needs of the UE. For instance, if the UE does not need frequent updates, the network may reduce the frequency of these transmissions, saving network energy and resources. Similarly, if the extra resources are added, the network may perform this adaptation carefully and based on need to avoid waste. For instance, if the network determines that it needs more frequent SSB measurements, it may adjust related parameters accordingly. On the other hand, if the UE is experiencing high collision and requests more PRACH resources, the network may be able to respond to this need. This request may be triggered by an uplink wake-up signal from the UE, indicating that the current PRACH configuration is not suitable and more PRACH resources are needed, for example. Moreover, the network may communicate to the UE that it is ready and capable of activating more resources, to account for situations where the network may not be configured or able to change its resource allocation at a given time.

Various aspects provide approaches for the network to provide certain indications to the UE to optimize the adaptation of common signals and channels, thereby enhancing network energy efficiency. These aspects, which provide an interactive and flexible approach to the adaptation of common signals and channels, may be provided alone or in combination with any of the described aspects. By allowing the network to indicate possible adaptations and the UE to request specific adaptations, more efficient use of network resources and energy may be provided, while also ensuring that the adaptations made are useful to the UEs.

In one aspect, the network may indicate to the UE the possible adaptations the base station may apply to common signals and channels. For instance, the base station may provide candidate configurations of one or more common signals or channels, such as multiple configurations respectively including different SSB periodicities, different quantities of PRACH resources, or a combination of such configurations, which the UE may select in a request. Such signaling allows the UE to determine whether the adaptation would be useful or not. This may help to avoid unnecessary adaptations that may not benefit the UE but could consume network resources and energy.

In another aspect, the network may indicate to the UE whether or not the UE may request the adaptation of common signals or channels in general. This indication may enable or disable a general feature of UE request of such common signals or channels. This indication may provide the UE with the flexibility to request adaptations based on its needs, while also giving the network control over when adaptations may be requested. If UE requests in general are disabled, this setting may save energy for the UE since the UE may refrain from transmitting unnecessary requests which the network will disregard. Moreover, disabling UE requests for adaptations may be useful for UEs at a cell edge, since adapting configurations of common signals or channels may not be of much help for these UEs and thus a handover to a different cell or other coverage changes may be more effective and efficient. For example, if the UE is located at an edge of a cell, the base station serving that cell may send system information to the UE disabling common signal and common channel adaptations and informing the UE to handover to another cell instead.

In a further aspect, the network may indicate to the UE which signals or channels the UE is allowed to request for adaptation. For example, the base station may indicate to the UE whether the UE may request adaptations only for SSBs, only for PRACH, or any combination of these and other common signals or channels. Such indication allows the network to restrict UE requests to certain signals or channels that the network is willing and able to adapt, thereby compacting UE requests and simplifying request signaling. This signal or channel-specific restriction may also help to ensure that the network's resources are used efficiently and that the adaptations made are useful to both the network and the UE. Moreover, this indication may be provided alternatively to, or in addition to, candidate configurations of common signals or channels available for adaptation.

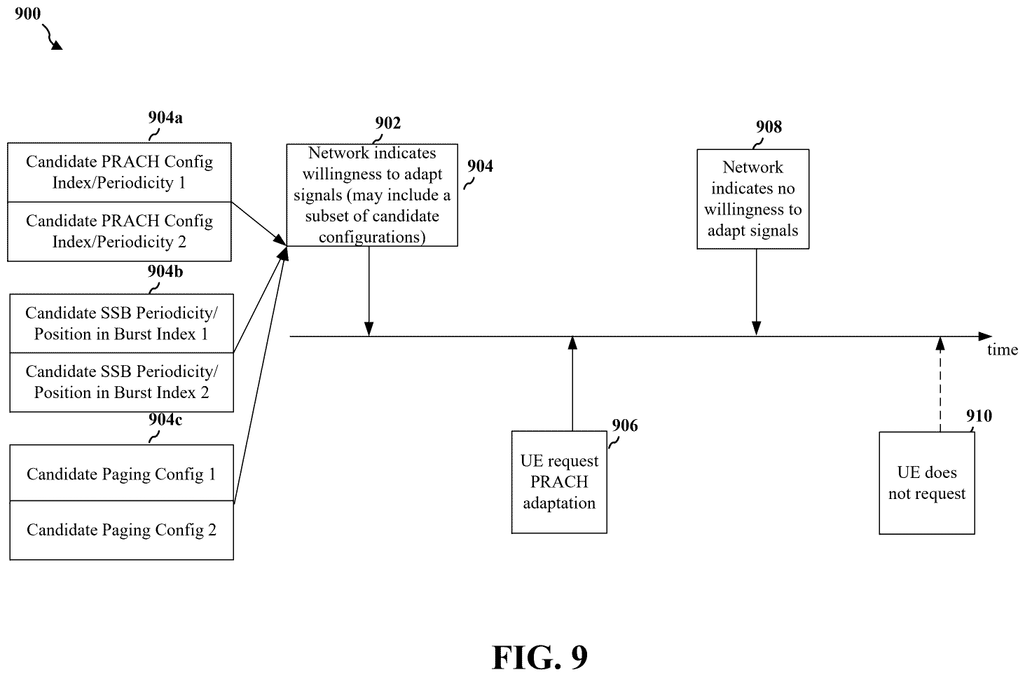

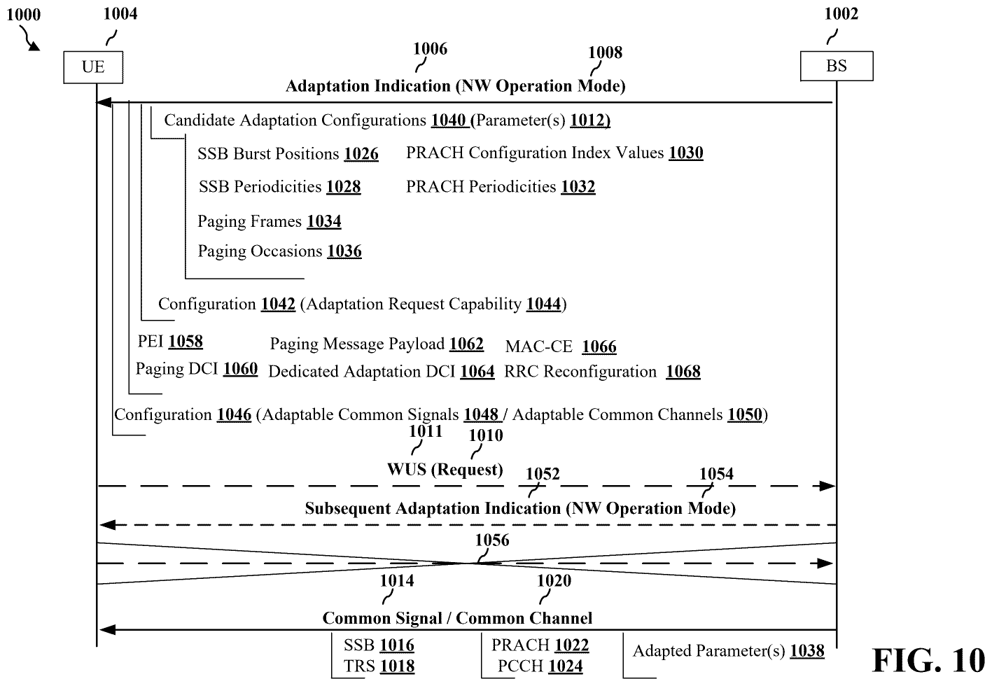

FIG. 9 illustrates an example 900 of a timeline illustrating an interaction between the network and the UE in the context of signal and channel adaptation. The sequence of events illustrated in this example between the network and the UE may enhance network energy efficiency. For instance, the network may not adapt a common signal or channel unless the UE indicates a need for it via a request, and the UE may not request an adaptation that the network is not configured or capable to adapt. This approach may result in efficient use of network resources from both the UE and network perspectives.

Initially, the base station may send an indication 902 to the UE that it is an operation mode to adapt certain common signals or channels. The adaptation may be, for example, a parameter change in a time domain, a frequency domain, or a spatial domain for an SSB, PRACH, PCCH, TRS, or other signal or channel common for multiple UEs. The indication 902 may inform the UE that the network is capable of adapting any common signal or channel in general, or only specifically indicated common signals or channels in indication 902. In some examples, the indication 902 may be provided through system information or an RRC configuration. For instance, the system information or RRC configuration may include a bit indicating the base station is in an operation mode or has capability to adapt common signals or channels in general, or a bitmap indicating the base station is in an operation mode or has capability to adapt certain common signals or channels specifically associated with a respective bit in the bitmap. For example, one bit may indicate whether SSBs are configured to be adapted, another bit may indicate whether PRACH resources are configured to be adapted, and the like. In other examples, the indication 902 may be similarly provided through a PEI, paging DCI, paging payload, other DCI, MAC-CE, RRC reconfiguration, or other signaling.

In some examples, this indication 902 may include a subset of candidate configurations 904 that the base station is in a operation mode or capability to apply for certain common signals or channels, such as illustrated in FIG. 9. For example, the base station may indicate that it is configured to adapt the PRACH in the time domain and provide a number of candidate configurations 904a which the network may apply for this purpose (e.g., one configuration including parameters such as PRACH configuration index 1 or PRACH periodicity 1, another configuration including parameters such as PRACH configuration index 2 or PRACH periodicity 2, and the like). Similarly, the base station may indicate that it is configured to adapt the SSB in the time domain and provide a number of candidate configurations 904b which the network may apply for this purpose (e.g., one configuration including parameters such as SSB periodicity 1 or SSB position in burst index 1, another configuration including parameters such as SSB periodicity 2 or SSB position in burst index 2, and the like). The base station may likewise indicate that it is configured to adapt paging and provide a number of candidate configurations 904c which the network may apply for this purpose (e.g., one configuration including paging configuration 1 with parameters such as one number of paging frames or POs, another configuration including paging configuration 2 with parameters such as another number of paging frames or POs, and the like). The base station may include candidate configurations 904 for one common signal or channel, or for multiple common signals or channels such as for any combination of SSB, PRACH, paging, or TRS. By defining adaptation candidates through at least these parameters or other parameters for such common signals or channels, the network may adapt its transmissions or UE transmissions based on current demand and conditions, leading to more efficient use of network resources. Moreover, while the illustrated example of FIG. 9 indicates the subset of candidate configurations 904 are included in indication 902, in other examples, the candidate configurations 904 may be provided in a separate indication than indication 902.

In one example of a subset of candidate configurations 904b for adapting SSBs, the network may indicate at least one of a set of multiple candidates for SSB burst position (e.g., SSB-positionInBursts), at least one of a set of multiple candidates for SSB periodicity, or a combination of at least one of either set. For example, the base station may define in each candidate a bitmap of values indicating different SS burst positions or different SSB periodicities. As an example with reference to FIG. 4, one candidate configuration may include an SS burst position bitmap value of ‘0101’ to indicate that SSBs on beams 2 and 4 are active or being transmitted, another candidate configuration may include an SS burst position bitmap value of ‘1010’ to indicate that SSBs on beams 1 and 3 are active or being transmitted, or the like. Alternatively or additionally, different candidate configurations may respectively include SSB periodicity 404 of 5 ms, 20 ms, 40 ms, 80 ms, 160 ms, or other quantity of time for SSBs 402.

In another example of a subset of candidate configurations 904a for adapting PRACH in the time domain, the network may indicate at least one of a set of multiple candidates for PRACH configuration index values (e.g., PRACHconfigurationIndex), at least one of a set of multiple candidates for PRACH periodicity, or a combination of at least one of either set. For example, the base station may define in each candidate a different PRACH configuration index value or PRACH periodicity. As an example with reference to FIG. 5, one candidate configuration may include a PRACH configuration index value of 70, another candidate configuration may include a PRACH configuration index value of 71, or the like. Alternatively or additionally, different candidate configurations may respectively include a different PRACH periodicity indicated by different x and y values for frame numbers, or other different PRACH timings indicated by different subframe numbers, slot numbers, starting symbols, or other time related parameters in table 506. Thus, for example, one candidate configuration may change PRACH configuration index 71 to have a different PRACH periodicity or other timing parameter than that illustrated in table 506. While adapting PRACH by changing the PRACH configuration index may be simpler, adapting PRACH by changing the PRACH periodicity or other timing parameter may be more compatible with UEs that are not capable of requesting or applying adaptations of common signals or channels.

In another example of a subset of candidate configurations 904a for adapting PRACH in the spatial domain, such as changing the number of PRACH occasions per SSB, the network may indicate at least two of a set of multiple candidates for SS burst position (e.g., SSB-positionInBursts). For example, the base station may define, in each candidate, multiple bitmaps of values respectively indicating different SS burst positions, and the UE may then determine from the multiple SS burst positions the number of PRACH occasions associated with each SSB. Generally, a fixed number of PRACH occasions are assigned per SSB using RO mapping configurations such as msg1-FDM and ssb-perRACH-OccasionAndCB-PreamblesPerSSB. Each SSB is associated with a same number of ROs in the SS burst in this manner, such as one RO for each SSB or two ROs for each SSB, resulting in a constant distribution of PRACH occasions per SSB. However, by using multiple SS burst position definitions in a given candidate configuration, the network may effectively assign a different number of ROs per SSB in the RO mapping configurations, for instance, two ROs for some SSBs and one RO for other SSBs in the same SS burst, resulting in a varied distribution of PRACH occasions per SSB. As an example with reference to FIGS. 4 and 5, the base station may indicate in RO mapping configuration(s) that two ROs 502 are associated with one SSB 402, for example, using a value of two for msg1-FDM and a value of one half for ssb-perRACH-OccasionAndCB-PreamblesPerSSB. The base station may also provide in a single candidate configuration one SS burst position value of 1111 to indicate that SSBs 402 on beams 1, 2, 3, and 4 are active, and another SS burst position value of 1100 to indicate that SSBs 402 on beams 1 and 2 are active. In such case, the UE may interpret the RO mapping configuration(s) such that two ROs 502 are associated with each SSB 402 on beams 1 and 2, while one RO 502 is associated with each SSB 402 on beams 3 and 4.

In a further example of a subset of candidate configurations 904c for adapting paging, the network may indicate at least one of a set of multiple candidates for a number of paging frames (N), at least one of a set of multiple candidates for a number of paging occasions (Ns or N_s), or a combination of at least one of either set. For example, the base station may define in each candidate a different number of paging frames per paging cycle (N) or a different number of paging occasions per paging frame (Ns). As an example with reference to FIG. 6, one candidate configuration may include four paging frames 602 per paging cycle or four POs 604 per paging frame 602, while another candidate configuration may include a different number of paging frames 602 per paging cycle or a different number of POs per paging frame.

In some examples, the base station may provide an indication (not shown) informing the UE that the UE is allowed to or capable of sending a WUS to the base station requesting an adaptation in the configuration of an SSB, PRACH, paging, TRS, or other common signal or channel. In some examples, this indication may be included in the same signaling as indication 902 or subset of candidate configurations 904. In other examples, this indication may be included in separate signaling from indication 902 or subset of candidate configurations 904. This indication may enable or disable the UE's capability to request adaptations of common signals or channels in general, or to request adaptations of specifically indicated common signals or channels. For instance, this indication may enable or disable the UE to request an adaptation of whichever common signals or channels are provided in candidate configurations 904.

The indication informing whether or not the UE may request common signal or channel adaptation, or whether or not the base station may accept a cell WUS requesting such adaptation, may be carried out using one of several approaches. In one approach, the indication may be or may be included in a PEI or early indication, such as PEI 702. For instance, the base station may send an early indication along with a paging signal, which early indication may inform the UE that the UE is allowed to send a WUS requesting an adaptation of any common signal or channel or of certain indicated common signals or channels. In another approach, the indication may be or may be included in a paging DCI, such as a DCI having a DCI format 1_0 with a CRC scrambled by a P-RNTI. For instance, the base station may send a DCI along with a paging signal in PO 604, which DCI may inform the UE that the UE is allowed to send a WUS requesting an adaptation of any common signal or channel or of certain indicated common signals or channels. This indication may be separate from a short message in paging DCI, which short message informs UEs whether a change has occurred in system information and to wake up to monitor for such changed system information accordingly. The indications of the present disclosure may also occur dynamically and thus on a faster basis than changes in system information indicated in short messages, as well as be specific to a UE depending on the indication. In a further approach, the indication may be or may be included in a paging payload, such as a paging message indicated via a paging DCI in PO 604. For instance, the base station may send a paging message to the UE in PO 604, which payload may inform the UE that the UE is allowed to send a WUS requesting an adaptation of any common signal or channel or of certain indicated common signals or channels. In another approach, the indication may be or may be included in a dedicated DCI to the UE for common signal or channel adaptation, which DCI may be separate from a paging DCI or other DCI scheduling data for the UE. For instance, the base station may send a DCI having a DCI format dedicated for informing the UE that the UE is allowed to send a WUS requesting an adaptation of any common signal or channel or of certain indicated common signals or channels. In another approach, the indication may be or may be included in a MAC-CE or RRC reconfiguration for connected UEs. For instance, the base station may send a MAC-CE or RRC reconfiguration to the UE, which configuration may inform the UE that the UE is allowed to send a WUS requesting an adaptation of any common signal or channel or of certain indicated common signals or channels.

After receiving the network's indication 902 that the base station is in an operation mode to adapt common signals or channels, including, in same or separate signaling, the subset of candidate configurations 904 or an indication that the UE is allowed request common signal or channel adaptation, the UE may transmit a request 906 for the adaptation of a common signal or channel. The request 906 may be a WUS such as a PRACH preamble transmission, for example. In the example of FIG. 9, the UE is requesting a PRACH adaptation, but in other examples, the UE may request an adaptation for a different common channel or signal. This request 906 may based on the UE's needs and the candidate configurations 904 provided by the network. For instance, in the example of FIG. 9, the UE may request the base station to associate subsequent ROs to those illustrated in FIG. 5 with PRACH configuration index 72, and the UE may transmit preamble in the adapted ROs accordingly. While this example assumes the base station performs the UE requested adaptation in response to the request 906, in other examples, the base station may perform a different adaptation than that requested by the UE based on other factors, or the base station may not or decline to perform the adaptation requested by the UE.

The UE's transmission of request 906 may also be based on whether the base station provides candidate configurations 904 to the UE. In one example, the UE may send request 906 for adaptation of a particular common signal or channel in response to the base station providing multiple candidate configurations 904 for that common signal or channel. For instance, each candidate configuration 904 may include a different index, periodicity, or other parameter associated with a SSB, PRACH, PCCH, or TRS, such as illustrated via candidate configuration 904a, 904b, or 904c in FIG. 9, and the UE may optionally select one of these parameters and indicate the selected parameter in its request 906. In other examples, the base station may provide a single or default candidate configuration for a particular common signal or channel, or the base station may not provide any candidate configurations 904 along with its indication 902 that it is in a mode to adapt a particular common signal or channel. In some of these examples, the UE may send request 906 for adaptation of that common signal or channel without selecting a particular candidate configuration, since there is no configuration to select, and the base station may apply the default configuration for that adaptation. In others of these examples, the UE may not send any request 906 for that common signal or channel, since there is no configuration to select. Rather, the base station may simply apply a default or single adaptation for that common signal or channel after transmitting indication 902, while disregarding any request 906 from the UE if such request still happens to be sent.

Thus, in some examples, the network may not provide any candidate configurations 904, and instead, the UE may request an adaptation such as additional PRACH resources, additional SSB, additional paging, or the like, without specifying a specific candidate in request 906. For example, the UE may simply inform the network that the UE requests additional or less ROs in general using a single bit value in request 906, or additional or less SSBs, paging, and the like using other bits or bit values in request 906. In response to the request 906, the base station may apply a default adaptation configuration that increases the number of ROs available to the UE, for example by setting PRACH periodicity to a small, default or arbitrary value, or vice-versa. While this approach may not indicate to the network the exact adaptation the UE requests in contrast to candidate configurations 904, and thus may lead to more arbitrary adaptation results that may be more or less than the UE actually needs, this approach still allows for dynamic flexibility in the adaptation of common signals and channels.

At some point in time, the base station may send an indication 908 to the UE that it is no longer in an operation mode to adapt certain signals or channels. The indication 908 may include an identical or similar structure to indication 902. The indication 908 may inform the UE that the network is not configured or capable until further notice of adapting any common signal or channel in general, or only specifically indicated common signals or channels in indication 908. This indication 908 may be due to changes in the network's conditions or resources, such as in response to the base station determining it is applying more than a threshold amount of energy from monitoring additional resources following a prior adaptation, for example. After receiving the network's indication 908 that it is no longer or not in a mode to generally adapt common signals or channels or specifically adapt certain common signals or channels, the UE may refrain from transmitting any request 910 for further or new adaptations, since the UE may determine such requests 910 will be disregarded in any event at the base station.

FIG. 10 illustrates an example 1000 of a call flow diagram between a base station 1002 and a UE 1004. Here, base station 1002 may correspond to base station 102, 310, and UE 1004 may correspond to UE 104, 350. Initially, the base station 1002 may provide an adaptation indication 1006 to the UE 1004. The adaptation indication 1006 may correspond, for example, to indication 902 or indication 908 of FIG. 9. The adaptation indication 1006 may indicate whether the base station 1002 is in a network operation mode 1008 to perform common signal or channel adaptation based on a request 1010 from UE 1004. For instance, the network operation mode 1008 may be represented by a bit or other configuration which under one setting may indicate the base station 1002 is configured or capable of performing adaptations, and which under a different setting may indicate the base station 1002 is not configured or not capable of performing adaptations. The request 1010 may correspond, for example, to request 906 of FIG. 9. In some examples, the request 1010 may be transmitted in a WUS 1011 for the base station 1002 in response to indication 902.

When the base station 1002 is in the network operation mode 1008 to perform common signal or channel adaptations, the base station 1002 may change, in response to the request 1010 from UE 1004, one or more parameters 1012 associated with a common signal 1014 such as an SSB 1016 or TRS 1018 or a common channel 1020 such as a PRACH 1022 or a PCCH 1024 for multiple UEs 104 including UE 1004. The parameters 1012 may include, for example, an SS burst position or SSB burst position 1026, an SSB periodicity 1028, a PRACH configuration index value 1030, a PRACH periodicity 1032, a number of paging frames 1034, a number of paging occasions 1036, or at least one information element or configuration including any of these parameters or other parameters, in any combination. After transmitting the indication 1006 and receiving the request 1010 from UE 1004, the base station 1002 may provide the common signal 1014 or the common channel 1020 to the UE 1004 with one or more parameters 1038 of signal or channel having been adapted or changed accordingly.

In some examples, the indication 1006 may include one or more candidate configurations 1040 of the parameter(s) 1012 which the base station 1002 may adapt for common signal 1014 or common channel 1020. The common signal 1014 or common channel 1020 may include adapted parameter(s) 1038 which the UE 1004 requests from these candidate configuration(s) 1040 or which the base station 1002 may apply by default. The candidate configuration(s) 1040 may respectively include SSB burst positions 1026, SSB periodicities 1028, PRACH configuration index values 1030, PRACH periodicities 1032, numbers of paging frames 1034, numbers of paging occasions 1036, or other parameters 1012, in any combination.

In some examples, the indication 1006 may include a configuration 1042 indicating an adaptation request capability 1044 of the UE 1004. For instance, the configuration 1042 may inform the UE 1004 via adaptation request capability 1044 whether the UE is configured or capable of requesting an adaptation of one or more parameters 1012 of common signals 1014 or common channels 1020 in general, or in specifically indicated common signals or common channels. For example, the UE 1004 may determine from adaptation request capability 1044 whether or not the UE may transmit request 1010 in WUS 1011 for adapted parameter(s) 1038 to base station 1002. In other examples, the configuration 1042 may be provided in different signaling than indication 1006, or in same signaling as or different signaling than candidate configurations 1040.

In some examples, the indication 1006 may include a configuration 1046 identifying adaptable common signal(s) 1048 or adaptable common channel(s) 1050 which the base station 1002 may adapt in response to request 1010 from UE. For instance, if the base station indicates that any of SSBs 1016, TRS 1018, PRACH 1022, or PCCH 1024 are adaptable common signals 1048 or adaptable common channels 1050, the UE 1004 may provide request 1010 for the base station 1002 to adapt parameter(s) 1012 of the indicated signal(s) or channel(s). In other examples, the configuration 1046 may be provided in different signaling than indication 1006, or in same signaling as or different signaling than candidate configurations 1040 or configuration 1042.

In some examples, the base station 1002 may provide a subsequent adaptation indication 1052 to UE 1004. The adaptation indication 1052 may correspond, for example, to indication 908 of FIG. 9. The adaptation indication 1052 may indicate that the base station 1002 is in a network operation mode 1054 not to perform common signal or channel adaptation based on a request 1010 from UE 1004. For instance, the network operation mode 1054 may be represented by a bit or other configuration which under one setting may indicate the base station 1002 is not configured or not capable of performing adaptations. In response to this indication 1052, the UE 1004 may refrain from transmitting a request 1056 for subsequent common signal or channel adaptations. For instance, request 1056 may correspond to request 910 which the UE 1004 may refrain from sending to base station 1002 in FIG. 9.

In various examples, the indication 1006, candidate adaptation configurations 1040, configuration 1042, configuration 1046, or indication 1052 may be provided in a PEI 1058 such as PEI 702, a paging DCI 1060, a paging message payload 1062, a dedicated DCI 1064 for common signal or channel adaptation, a MAC-CE 1066, or a RRC reconfiguration 1068.

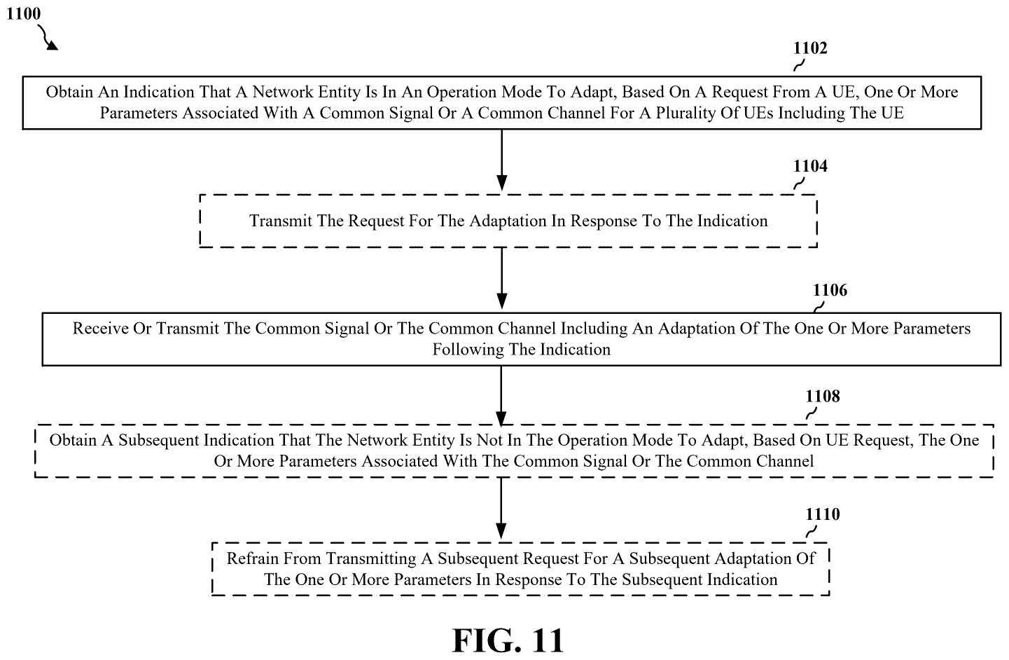

FIG. 11 is a flowchart 1100 of an example method or process for wireless communication. The method may be performed by a UE, such as the UE 104, 350, 1004, the apparatus 1202, or its components as described herein. The method allows a UE to efficiently communicate with a network by adapting to changes in common signals and channels based on the network's indications. This includes receiving indications from the network about possible adaptations, determining whether to request adaptations based on these indications, and transmitting requests for specific adaptations when necessary. This method enhances the energy efficiency of the UE's communication with the network by ensuring that adaptations are made based on the specific needs of the UE, thereby optimizing the use of network resources and energy.

At block 1102, the UE obtains an indication that a network entity is in an operation mode to adapt, based on a request from a UE, one or more parameters associated with a common signal or a common channel for a plurality of UEs including the UE. For example, block 1102 may be performed by indication component 1240. For instance, referring to the Figures, the controller(s)/processor(s) 359 or RX processor(s) 356 of UE 1004 at block 1102 may receive indication 1006 that base station 1002 is in operation mode 1008 to adapt, based on request 1010 from UE 1004, one or more parameters 1012 associated with common signal 1014 or common channel 1020 for multiple UEs 104 including UE 1004. In one example, the indication may be obtained in a PEI. For instance, referring to the Figures, indication 1006 may be received in PEI 1058. In one example, the indication may be obtained in paging DCI. For instance, referring to the Figures, indication 1006 may be received in paging DCI 1060. In one example, the indication may be obtained in a payload of a paging message. For instance, referring to the Figures, indication 1006 may be received in paging message payload 1062. In one example, the indication may be obtained in DCI dedicated for common signal adaptations or common channel adaptations. For instance, referring to the Figures, indication 1006 may be received in dedicated DCI 1064. In one example, the indication may be obtained in a MAC-CE or a RRC reconfiguration for connected UEs. For instance, referring to the Figures, indication 1006 may be received in MAC-CE 1066 or RRC reconfiguration 1068.

In various examples, the indication may include a plurality of candidate configurations of the one or more parameters for the common signal or the common channel, and the adaptation may be based on one of the candidate configurations. For instance, referring to the Figures, the indication 1006 may include candidate configurations 1040 of parameter(s) 1012 for common signal 1014 or common channel 1020, and the adapted parameter(s) 1038 may be based on one of these candidate configurations 1040. In one example, the common signal is a SSB, and the plurality of candidate configurations include at least one of multiple SSB burst positions or multiple SSB periodicities. For instance, referring to the Figures, where common signal 1014 is SSB 1016, each of candidate configurations 1040 may include a different SSB burst position 1026, a different SSB periodicity 1028, or both. In one example, the common signal is a PRACH, and the plurality of candidate configurations include at least one of multiple PRACH configuration index values or multiple PRACH periodicities. For instance, referring to the Figures, where common channel 1020 is PRACH 1022, each of candidate configurations 1040 may include a different PRACH configuration index value 1030, a different PRACH periodicity 1032, or both. In one example, the common signal is a PRACH, and the plurality of candidate configurations include multiple SSB burst positions. For instance, referring to the Figures, where common channel 1020 is PRACH 1022, each of candidate configurations 1040 may include multiple different SSB burst positions 1026. In one example, the common signal is a PCCH, and the plurality of candidate configurations include at least one of multiple quantities of paging frames or multiple quantities of paging occasions. For instance, referring to the Figures, where common channel 1020 is PCCH 1024, each of candidate configurations 1040 may include a different number of paging frames 1034, a different number of paging occasions 1036, or both.

At block 1104, the UE may transmit the request for the adaptation in response to the indication obtained at block 1102. For example, block 1104 may be performed by request component 1244. For instance, referring to the Figures, the controller(s)/processor(s) 359, or TX processor(s) 368 of UE 1004 at block 1104 may transmit request 1010 for adapted parameters 1038 in response to indication 1006. In such case, the common signal 1014 or common channel 1020 may include the adapted parameters 1038 in response to request 1010. In one example, the indication includes a configuration indicating a capability of the apparatus to request the adaptation of the one or more parameters for the common signal or the common channel. For instance, referring to the Figures, indication 1006 may include configuration 1042 including capability 1044 of UE 1004 to send request 1010 for adapted parameter(s) 1038 of common signals 1014 or common channels 1020. In one example, the request may be a WUS for the network entity. For instance, referring to the Figures, request 1010 may be transmitted via WUS 1011 for base station 1002. In one example, the indication includes a configuration identifying common signals or common channels for which the apparatus is capable to request the adaptation. For instance, referring to the Figures, indication 1006 may include configuration 1046 identifying common signals 1014 or common channels 1020 for which UE 1004 may transmit request 1010 for adapted parameter(s) 1038.

At block 1106, the UE may receive or transmit the common signal or the common channel including an adaptation of the one or more parameters following the indication. For example, block 1106 may be performed by communication component 1242. For instance, referring to the Figures, the controller(s)/processor(s) 359, RX processor(s) 356, or TX processor(s) 368 of UE 1004 at block 1106 may transmit or receive common signal 1014 or common channel 1020 including adapted parameter(s) 1038 following reception of indication 1006. In one example, the common signal may be a SSB or a TRS, and the common channel may be a PRACH or a PCCH. For instance, referring to the Figures, common signal 1014 may be SSB 1016 or TRS 1018, and common channel 1020 may be PRACH 1022 or PCCH 1024.

At block 1108, the UE may obtain a subsequent indication that the network entity is not in the operation mode to adapt, based on UE request, the one or more parameters associated with the common signal or the common channel. For example, block 1108 may be performed by indication component 1240. For instance, referring to the Figures, the controller(s)/processor(s) 359 or RX processor(s) 356 of UE 1004 at block 1108 may receive indication 1052 that base station 1002 is not in operation mode 1008 to adapt parameters 1012 associated with common signals 1014 or common channels 1020 based on request 1010 from UE 1004.

At block 1110, the UE may refrain from transmitting a subsequent request for a subsequent adaptation of the one or more parameters in response to the subsequent indication. For example, block 1110 may be performed by request component 1244. For instance, referring to the Figures, the controller(s)/processor(s) 359 or TX processor(s) 368 of UE 1004 at block 1110 may omit transmitting request 1056 for adapted parameter(s) 1038 of common signals 1014 or common channels 1020 in response to indication 1052.

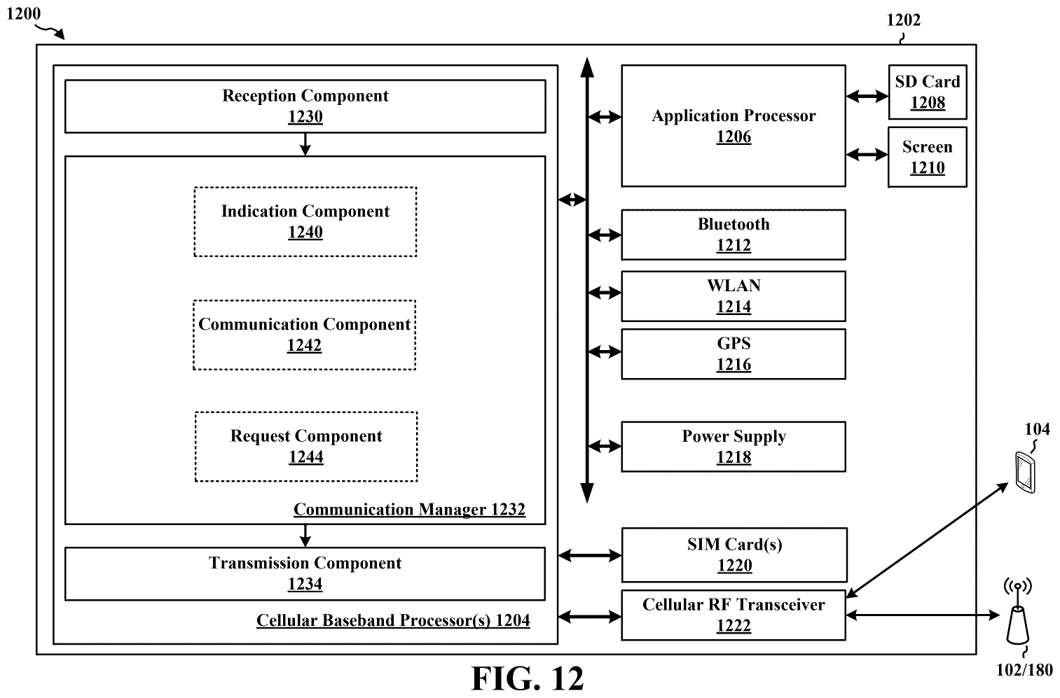

FIG. 12 is a diagram 1200 illustrating an example of a hardware implementation for an apparatus 1202 according to the various aspects of the present disclosure. In one example, the apparatus 1202 may be a UE such as UE 104, 350, 1004 and includes one or more cellular baseband processors 1204 (also referred to as a modem) coupled to a cellular RF transceiver 1222 and one or more subscriber identity modules (SIM) cards 1220, an application processor 1206 coupled to a secure digital (SD) card 1208 and a screen 1210, a Bluetooth module 1212, a wireless local area network (WLAN) module 1214, a Global Positioning System (GPS) module 1216, and a power supply 1218. The one or more cellular baseband processors 1204 communicate through the cellular RF transceiver 1222 with the BS 102. For example, the cellular RF transceiver 1222 may correspond to or include the transmitters 354TX, receivers 354RX, and antennas 352 of UE 350.

The one or more cellular baseband processors 1204 may each include a computer-readable medium/one or more memories. The computer-readable medium/one or more memories may be non-transitory. The one or more cellular baseband processors 1204 are responsible for general processing, including the execution of software stored on the computer-readable medium/one or more memories individually or in combination. The software, when executed by the one or more cellular baseband processors 1204, causes the one or more cellular baseband processors 1204 to, individually or in combination, perform the various functions described supra. The computer-readable medium/one or more memories may also be used individually or in combination for storing data that is manipulated by the one or more cellular baseband processors 1204 when executing software. The one or more cellular baseband processors 1204 individually or in combination further include a reception component 1230, a communication manager 1232, and a transmission component 1234. The communication manager 1232 includes the one or more illustrated components. The components within the communication manager 1232 may be stored in the computer-readable medium/one or more memories and/or configured as hardware within the one or more cellular baseband processors 1204. The one or more cellular baseband processors 1204 may be components of the UE 104, 350, 1004 and may individually or in combination include the one or more memories 360 and/or at least one of the one or more TX processors 368, at least one of the one or more RX processors 356 and at least one of the one or more controllers/processors 359. For example, the computer-readable medium/one or more memories may correspond to or include the one or more memories 360, the reception component 1230 may correspond to or include the one or more RX processors 356, the communication manager 1232 may correspond to or include the one or more controllers/processors 359, and the transmission component 1234 may correspond to or include the one or more TX processors 368. In one configuration, the apparatus 1202 may be a modem chip and include just the one or more baseband processors 1204, and in another configuration, the apparatus 1202 may be the entire UE (e.g., UE 350 of FIG. 3) and include the afore discussed additional modules of the apparatus 1202.

The communication manager 1232 may include an indication component 1240 that is configured to obtain an indication that a network entity is in an operation mode to adapt, based on a request from a user equipment (UE), one or more parameters associated with a common signal or a common channel for a plurality of UEs including the UE, such as described in connection with block 1102 of FIG. 11. The indication component 1240 may also in one configuration be configured to obtain a subsequent indication that the network entity is not in the operation mode to adapt, based on UE request, the one or more parameters associated with the common signal or the common channel, such as described in connection with block 1108 of FIG. 11. The communication manager 1232 may also include a communication component 1242 that is configured to receive or transmit the common signal or the common channel including an adaptation of the one or more parameters following the indication, such as described in connection with block 1106 of FIG. 11. The communication manager 1232 may also include a request component 1244 that is configured to transmit a request for the adaptation in response to the indication, where the common signal or the common channel includes the adaptation in response to the request, such as described in connection with block 1104 of FIG. 11. The request component 1244 may also in one configuration be configured to refrain from transmitting a subsequent request for a subsequent adaptation of the one or more parameters in response to the subsequent indication, such as described in connection with block 1110 of FIG. 11.

The apparatus may include additional components that perform each of the blocks of the algorithm in the aforementioned flowcharts of FIGS. 10 and 11. As such, each block in the aforementioned flowcharts of FIGS. 10 and 11 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1202, and in particular the one or more cellular baseband processors 1204, includes means for obtaining an indication that a network entity is in an operation mode to adapt, based on a request from a UE, one or more parameters associated with a common signal or a common channel for a plurality of UEs including the UE; and means for receiving or transmitting the common signal or the common channel including an adaptation of the one or more parameters following the indication. In one configuration, the means for transmitting may be further configured to transmit the request for the adaptation in response to the indication, wherein the common signal or the common channel includes the adaptation in response to the request. In one configuration, means for obtaining may be further configured to obtain a subsequent indication that the network entity is not in the operation mode to adapt, based on UE request, the one or more parameters associated with the common signal or the common channel; and the means for transmitting may be further configured to refrain from transmitting a subsequent request for a subsequent adaptation of the one or more parameters in response to the subsequent indication.

The aforementioned means may be one or more of the aforementioned components of the apparatus 1202 configured to perform the functions recited by the aforementioned means. Moreover, as described supra, the apparatus 1202 may include the one or more TX Processors 368, the one or more RX Processors 370, and the one or more controllers/processors 359. As such, in one configuration, the aforementioned means may be at least one of the one or more TX Processors 368, at least one of the one or more RX Processors 356, or at least one of the one or more controllers/processors 359 individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain an indication that a network entity is in an operation mode to adapt, based on a request from a user equipment (UE), one or more parameters associated with a common signal or a common channel for a plurality of UEs including the UE; and receive or transmit the common signal or the common channel including an adaptation of the one or more parameters following the indication.

Clause 2. The apparatus of clause 1, wherein the indication includes a plurality of candidate configurations of the one or more parameters for the common signal or the common channel, and the adaptation is based on one of the candidate configurations.

Clause 3. The apparatus of clause 2, wherein the common signal is a synchronization signal block (SSB), and the plurality of candidate configurations include at least one of: multiple SSB burst positions, or multiple SSB periodicities.

Clause 4. The apparatus of clause 2 or clause 3, wherein the common channel is a physical random access channel (PRACH), and the plurality of candidate configurations include at least one of: multiple PRACH configuration index values, or multiple PRACH periodicities.

Clause 5. The apparatus of any of clauses 2 to 4, wherein the common channel is a physical random access channel (PRACH), and the plurality of candidate configurations include multiple SSB burst positions.

Clause 6. The apparatus of any of clauses 2 to 5, wherein the common channel is a paging control channel (PCCH), and the plurality of candidate configurations include at least one of: multiple quantities of paging frames, or multiple quantities of paging occasions.

Clause 7. The apparatus of any of clauses 1 to 6, wherein the one or more processors, individually or in any combination, are operable to cause the apparatus to: transmit the request for the adaptation in response to the indication, wherein the common signal or the common channel includes the adaptation in response to the request.

Clause 8. The apparatus of any of clauses 1 to 7, wherein the indication includes a configuration indicating a capability of the apparatus to request the adaptation of the one or more parameters for the common signal or the common channel.

Clause 9. The apparatus of clause 8, wherein the common signal is a synchronization signal block (SSB) or a tracking reference signal (TRS), and the common channel is a physical random access channel (PRACH) or a paging control channel (PCCH).

Clause 10. The apparatus of clause 8 or clause 9, wherein the request is a wake-up signal (WUS) for the network entity.

Clause 11. The apparatus of clause 8 or clause 9, wherein the indication is obtained in a paging early indication (PEI).

Clause 12. The apparatus of clause 8 or clause 9, wherein the indication is obtained in paging downlink control information (DCI).

Clause 13. The apparatus of clause 8 or clause 9, wherein the indication is obtained in a payload of a paging message.

Clause 14. The apparatus of clause 8 or clause 9, wherein the indication is obtained in downlink control information (DCI) dedicated for common signal adaptations or common channel adaptations.

Clause 15. The apparatus of clause 8 or clause 9, wherein the indication is obtained in a medium access control (MAC)-control element (MAC-CE) or a radio resource control reconfiguration for connected UEs.

Clause 16. The apparatus of any of clauses 1 to 15, wherein the indication includes a configuration identifying common signals or common channels for which the apparatus is capable to request the adaptation.

Clause 17. The apparatus of any of clauses 1 to 16, wherein the one or more processors, individually or in any combination, are operable to cause the apparatus to: obtain a subsequent indication that the network entity is not in the operation mode to adapt, based on UE request, the one or more parameters associated with the common signal or the common channel; and refrain from transmitting a subsequent request for a subsequent adaptation of the one or more parameters in response to the subsequent indication.

Clause 18. A method of wireless communication performable at a user equipment (UE), comprising: obtaining an indication that a network entity is in an operation mode to adapt, based on a UE request, one or more parameters associated with a common signal or a common channel for a plurality of UEs including the UE; and receiving or transmitting the common signal or the common channel including an adaptation of the one or more parameters following the indication.

Clause 19. The method of clause 18, wherein the indication includes a plurality of candidate configurations of the one or more parameters for the common signal or the common channel, the adaptation is based on one of the candidate configurations, and the indication further includes a configuration indicating at least one of: a capability of the UE to request the adaptation of the one or more parameters for the common signal or the common channel, or an identification of common signals or common channels for which the UE is capable to request the adaptation.

Clause 20. An apparatus for wireless communication, comprising: means for obtaining an indication that a network entity is in an operation mode to adapt, based on a request from a user equipment (UE), one or more parameters associated with a common signal or a common channel for a plurality of UEs including the UE; and means for receiving or means for transmitting the common signal or the common channel including an adaptation of the one or more parameters following the indication.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain an indication that a network entity is in an operation mode to adapt, based on a request from a user equipment (UE), one or more parameters associated with a common signal or a common channel for a plurality of UEs including the UE; and
receive or transmit the common signal or the common channel including an adaptation of the one or more parameters following the indication.

2. The apparatus of claim 1, wherein the indication includes a plurality of candidate configurations of the one or more parameters for the common signal or the common channel, and the adaptation is based on one of the candidate configurations.

3. The apparatus of claim 2, wherein the common signal is a synchronization signal block (SSB), and the plurality of candidate configurations include at least one of:
multiple SSB burst positions, or
multiple SSB periodicities.

4. The apparatus of claim 2, wherein the common channel is a physical random access channel (PRACH), and the plurality of candidate configurations include at least one of:
multiple PRACH configuration index values, or
multiple PRACH periodicities.

5. The apparatus of claim 2, wherein the common channel is a physical random access channel (PRACH), and the plurality of candidate configurations include multiple SSB burst positions.

6. The apparatus of claim 2, wherein the common channel is a paging control channel (PCCH), and the plurality of candidate configurations include at least one of:
multiple quantities of paging frames, or
multiple quantities of paging occasions.

7. The apparatus of claim 1, wherein the one or more processors, individually or in any combination, are operable to cause the apparatus to:
transmit the request for the adaptation in response to the indication, wherein the common signal or the common channel includes the adaptation in response to the request.

8. The apparatus of claim 1, wherein the indication includes a configuration indicating a capability of the apparatus to request the adaptation of the one or more parameters for the common signal or the common channel.

9. The apparatus of claim 8, wherein the common signal is a synchronization signal block (SSB) or a tracking reference signal (TRS), and the common channel is a physical random access channel (PRACH) or a paging control channel (PCCH).

10. The apparatus of claim 8, wherein the request is a wake-up signal (WUS) for the network entity.

11. The apparatus of claim 8, wherein the indication is obtained in a paging early indication (PEI).

12. The apparatus of claim 8, wherein the indication is obtained in paging downlink control information (DCI).

13. The apparatus of claim 8, wherein the indication is obtained in a payload of a paging message.

14. The apparatus of claim 8, wherein the indication is obtained in downlink control information (DCI) dedicated for common signal adaptations or common channel adaptations.

15. The apparatus of claim 8, wherein the indication is obtained in a medium access control (MAC)-control element (MAC-CE) or a radio resource control reconfiguration for connected UEs.

16. The apparatus of claim 1, wherein the indication includes a configuration identifying common signals or common channels for which the apparatus is capable to request the adaptation.

17. The apparatus of claim 1, wherein the one or more processors, individually or in any combination, are operable to cause the apparatus to:
obtain a subsequent indication that the network entity is not in the operation mode to adapt, based on UE request, the one or more parameters associated with the common signal or the common channel; and
refrain from transmitting a subsequent request for a subsequent adaptation of the one or more parameters in response to the subsequent indication.

18. A method of wireless communication performable at a user equipment (UE), comprising:
obtaining an indication that a network entity is in an operation mode to adapt, based on a UE request, one or more parameters associated with a common signal or a common channel for a plurality of UEs including the UE; and
receiving or transmitting the common signal or the common channel including an adaptation of the one or more parameters following the indication.

19. The method of claim 18, wherein the indication includes a plurality of candidate configurations of the one or more parameters for the common signal or the common channel, the adaptation is based on one of the candidate configurations, and the indication further includes a configuration indicating at least one of:
a capability of the UE to request the adaptation of the one or more parameters for the common signal or the common channel, or
an identification of common signals or common channels for which the UE is capable to request the adaptation.

20. An apparatus for wireless communication, comprising:
means for obtaining an indication that a network entity is in an operation mode to adapt, based on a request from a user equipment (UE), one or more parameters associated with a common signal or a common channel for a plurality of UEs including the UE; and
means for receiving or means for transmitting the common signal or the common channel including an adaptation of the one or more parameters following the indication.
